(19) United States
(12) Patent Application Publication
(10) Pub. No.: US 2009/0044758 A1
(43) Pub. Date: Feb. 19, 2009

(54) COMPANION ANIMAL CONVENIENCE CENTER

(76) Inventors: Robert Adams, Bloomfield Hills, MI (US); Carol Jones-Adams, Bloomfield Hills, MI (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 12/162,596

(22) PCT Filed: Jan. 30, 2007
(86) PCT No.: PCT/US2007/002371

§ 371 Date: Jul. 29, 2008

Related U.S. Application Data
(60) Provisional application No. 60/763,741, filed on Jan. 30, 2006.

(51) Int. Cl. A01K 1/02; A01K 15/02

(52) U.S. Cl. 119/496; 119/721; 340/539.13; 119/28.5

(57) ABSTRACT

A companion animal convenience system for a motor vehicle has a moveable partition, said partition comprising a frame and netting attached said frame and said partition pivotally attached to a headliner of the vehicle; a removable bedding apparatus comprising at least one mattress, a plurality of compartments and a rubberized surface between said at least one mattress and the vehicle; and a collar operably sizeable to a companion animal and said collar in communication with the vehicle.

### CROSS-REFERENCE TO RELATED APPLICATIONS

This patent application claims the benefit of and priority to PCT Application No. PCT/US2007/02371 filed Jan. 30, 2007, which claims the benefit of and priority to U.S. Provisional Application Ser. No. 60/763,741, filed on Jan. 30, 2006. The disclosure of the above applications are incorporated herein by reference.

### BACKGROUND

As people travel in a motor vehicle, it has become common to bring along a companion animal such as, for instance, a family dog, a cat, a ferret, a lizard, or some other companion animal. Since motor vehicles are designed for human use, most animals do not have an area for their own use. In addition, when traveling with a companion animal, the companion animal may get separated from its owners due to a new and unfamiliar environment. What is needed is a convenience center for a motor vehicle which includes an area for the companion animal and a locating system for tracking the companion animal from the motor vehicle.

### SUMMARY

Accordingly, in some embodiments, a companion animal convenience system for a motor vehicle has a moveable partition, the partition attached to a headliner of the vehicle; a removable bedding apparatus comprising at least one mattress, a plurality of compartments and a rubberized surface between the at least one mattress and the vehicle; and a collar operably sizeable to a companion animal and the collar in communication with the vehicle.

In some embodiments, a companion animal locating system includes a vehicle having an antenna operable to receive a signal; and a collar sizable to a companion animal, the collar in communication with the vehicle. The system can include GPS in the vehicle and the signal can be described by the GPS. In some embodiments, the antenna can be operable to broadcast a signal and the collar is operable to receive the signal. In some embodiments, the antenna broadcasts a directional signal which is a boundary that contains the collar. In some embodiments, the antenna broadcasts when a vehicle door is unlocked. The system may include a moveable partition, the partition comprising a frame and netting attached the frame and the partition pivotally attached to a headliner of the vehicle. The system may include a removable bedding apparatus having at least one mattress, a plurality of compartments and a rubberized surface between the mattress and the vehicle.

The present teachings provide methods of locating a companion animal. In some embodiments, a method of finding an animal includes providing a vehicle having an antenna that is operable for at least one of broadcasting and receiving a signal to a call center; fitting the animal with a collar that is in communication with the vehicle; communicating the call center for a location of the animal wearing the collar; identifying the location of the animal wearing the collar; and driving the vehicle to the location of the animal wearing the collar. Methods may include the use of a GPS system in determining a location of an animal wearing the collar. Method are disclosed for containing an animal in an area by broadcasting a signal from a vehicle and creating a boundary that contains the animal wearing a collar that is communication with the vehicle.

Further areas of applicability will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present disclosure in any way.

FIG. 1 is a perspective view of the Companion Animal Convenience Center.

FIG. 2 is a rear-perspective view of the Companion Animal Convenience Center.

FIG. 3 is a block diagram of some embodiments of the present teachings.

FIG. 4 is a block diagram of some embodiments of the present teachings.

FIG. 5 is a block diagram of some embodiments of the present teachings.

FIG. 6 is a block diagram of some embodiments of the present teachings.

FIG. 7 is a block diagram of some embodiments of the present teachings.

FIG. 8 is a block diagram of some embodiments of the present teachings.

FIG. 9 is a block diagram of some embodiments of the present teachings.

FIG. 10 is a block diagram of some embodiments of the present teachings.

### DETAILED DESCRIPTION

The following description of technology is merely exemplary in nature of the subject matter, manufacture and use of one or more embodiments, and is not intended to limit the scope, application, or uses of any specific embodiments of the some embodiments claimed in this application or in such other applications as may be filed claiming priority to this application, or patents issuing therefrom. The following definitions and non-limiting guidelines must be considered in reviewing the description of the technology set forth herein. In particular, although the present disclosure will be discussed in some embodiments to locating a companion animal wearing a collar that is communication with a motor vehicle, such discussion should not be regarded as limiting the present disclosure to only such applications.

The headings (such as “Introduction” and “Summary”) and sub-headings used herein are intended only for general organization of topics within the present disclosure, and are not intended to limit the disclosure of the technology or any aspect thereof. In particular, subject matter disclosed in the “Introduction” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Detailed Description” section of this specification are hereby incorporated by reference in their entirety, for all purposes. In the event that one or more of the incorporated references, literature, and similar materials differs from or contradicts this application, including but not limited to defined terms, term usage, described techniques, or the like, this application controls.

The description and specific examples, while indicating some embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the compositions and methods of this technology and, unless explicitly stated otherwise, are not intended to be a representation that given some embodiments of this technology have, or have not, been made or tested.

The present technology provides a companion animal convenience system for a motor vehicle, the system comprising a moveable partition, the partition comprising a frame and netting attached the frame and the partition pivotally attached to a headliner of the vehicle; a removable bedding apparatus comprising at least one mattress, a plurality of compartments and a rubberized surface between the at least one mattress and the vehicle; and a collar operably sizeable to a companion animal and the collar in communication with the vehicle.

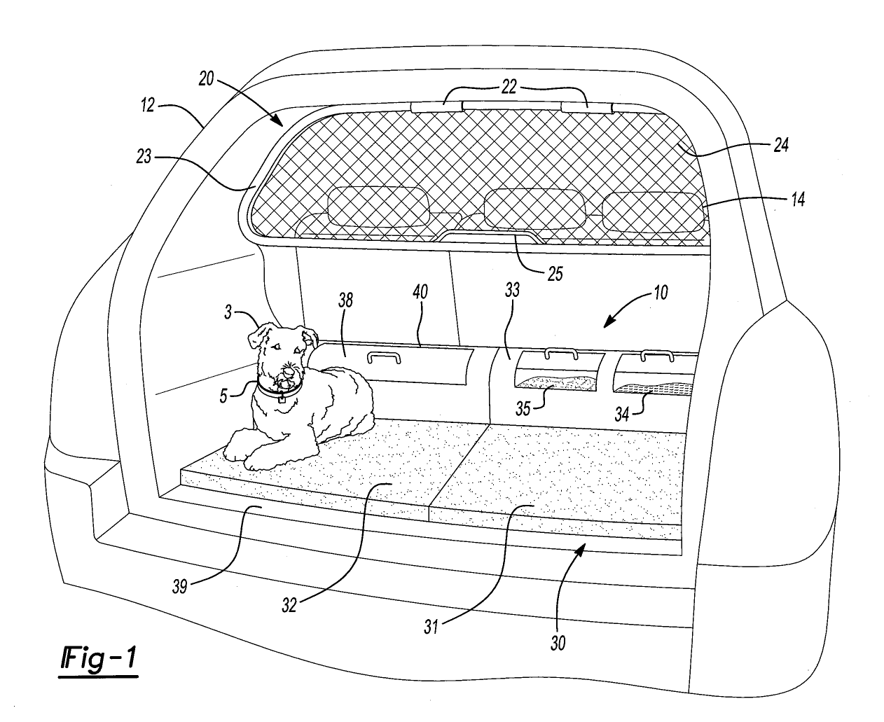

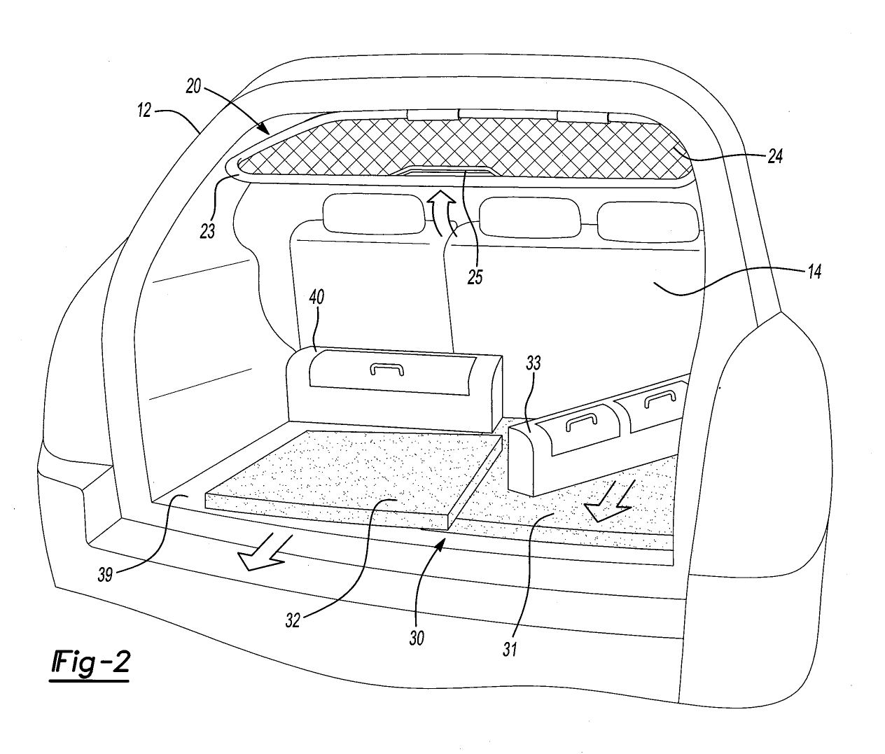

With reference to FIGS. 1 and 2, in some embodiments, the present disclosure provides a bed system 30 designed for a companion animal 3. The bed system 30 can be designed for the rear of the motor vehicle 12. In some embodiments, the motor vehicle 12 can be an SUV, a van, a station wagon or a hatch back. In some embodiments, the bed system 30 can include at least one mattress 31 and, in some embodiments, a second mattress 32. The bed system 30 can include a plurality of compartments 33, 40. The plurality of compartments 33, 40 can rest against a rear passenger seat 14 of motor vehicle 12. In some embodiments, one of the plurality of compartments 33 can contain one or more access points 34, 35. In some embodiments, an access point 34 can include a door and can be an insulated bowl for liquids such as water for companion animal 3. In some embodiments, another access point 35 can include a door and a bowl for holding food such as dog food for companion animal 3. In some embodiments, another of the plurality of compartments 33, 40 can include an access point 38 which can be storage area for a companion animal's toys, clothing, collars, leashes or other such items. The bed system 30 can include rubberized surface 39 which is below the at least one mattress 31. In some embodiments, the rubberized surface 39 is permanently held to motor vehicle 12 and such can be accomplished by spraying the rubberized surface 39 or by using adhesive to hold the rubberized surface 39 to motor vehicle 12. In some embodiments, the rubberized surface 39 can be on a bottom surface of the at least one mattress 31 or on an entire bottom surface of the bed system 30. In some embodiments, bed system 30 can be removable as shown in FIG. 2, and partition 20 can pivot at fasteners 22 and lock on headliner roof being essentially parallel to the wheelbase of motor vehicle 12. In some embodiments, companion animal convenience system 10 includes bed system 30.

In some embodiments, companion animal convenience system 10 includes a partition 20 between an area for companion animal 3 and an area for humans (for example, the area where a human can sit on seat 14). Partition 20 includes frame 23, netting 24 and fasteners 22 which can be fastened to an interior headliner or roof of motor vehicle 12. In some embodiments, frame 23 can pivot within fasteners 22. In some embodiments, partition 20 can include the handle 25. In some embodiments, the fasteners 22 can have a locking mechanism included such that partition 20 locks within the fasteners 22 so that partition 20 is locked in a substantially perpendicular manner as referenced to the wheelbase of motor vehicle 12. In some embodiments, partition 20 can have locking straps, Velcro, tabs, fasteners or the like that are located on the backside of seat 14 and such can be used to hold partition 20 securely against the back of seat 14 such that partition 20 is in a substantially perpendicular manner as referenced to the wheelbase of motor vehicle 12. In some embodiments, the companion animal convenience system 10 comprises bed system 30 and partition 20.

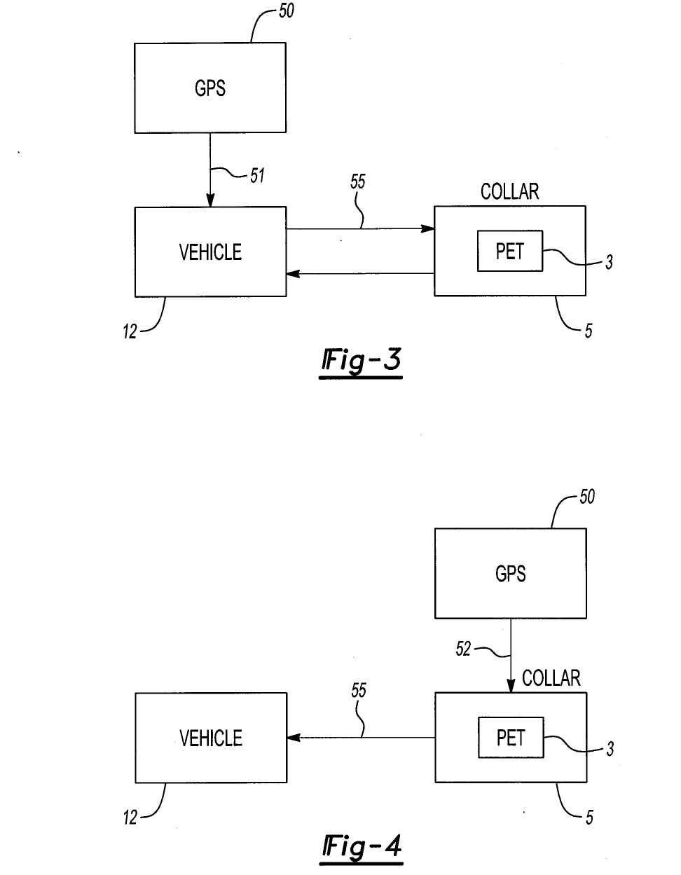

In some embodiments, companion animal convenience system 10 comprises bed system 30, partition 20, and collar 5. In some embodiments, collar 5 can include some type of electronic device that allows for tracking of companion animal 3 by use of collar 5 and motor vehicle 12. With reference to FIG. 3, in some embodiments, motor vehicle 12 can be in communication 51 with Global Positioning Satellites such that a global position system 50 can identify the exact location of a motor vehicle 12. Such systems are well-known in the art and can be purchased from vendors such as Garmen and Magellan. Other such systems are know in the art for vehicles and can be found, for example, US Patent Publication Nos. 2005/0038598 and 2005/0256615; and U.S. Pat. No. 6,580,390, as well as commercially available on GM vehicles with an OnStar™ System. Such GPS technology is well-known to those in the art and can be easily implemented to a motor vehicle 12. Other examples of such GPS technology exists in military applications with the satellite systems. An example of a GPS satellite system is maintained by the US Government.

Motor vehicle 12 of FIG. 3 can be in communication 55 with companion animal collar 5 that is on companion animal 3 and such companion animal 3 can be a dog, a cat, a ferret, a lizard, a bird, a horse or any other domestic or wild animal. In any embodiments, companion animal 3 can be replaced with a human, such as a child or an elderly relative and the collar 5 can be worn as an arm or ankle bracelet. In reference to FIG. 3, motor vehicle 12 communication 55 with collar 5 can be two-way communication and such communication can be by a two-way radio, infrared tracking, microwave tracking, RFID tracking, or the like. The collar 5 can have a receiver to receive a signal from vehicle 12 and an antenna to broadcast a return signal to motor vehicle 12 which has a receiver to catch the return signal. An example of the technology of a collar 5 can be found in U.S. Pat. Nos. 6,502,060 and 6,721,681. Examples of GPS on collars 5 include U.S. Pat. Nos. 6,172,640, 6,236,358, 6,421,001, 6,441,778, 6,480,147, 6,518,919, 6,771,213 and 6,859,171. Other examples have been shown throughout the art for a collar 5 that can be in communication with a receiver or for a collar 5 that can receive a communication. Some embodiments as shown in FIG. 3 of communication 55 is between motor vehicle 12 and collar 5. In some embodiments, motor vehicle 12 can have a tracking device so that an occupant in motor vehicle 12 can track companion animal 3. Using such a tracking device can be in the vehicle navigation system such that the occupant can track the companion animal 3 wearing collar 5 in communication 55 with motor vehicle 12 on roads or off roads by having the navigation system calculate quickest route to companion animal 3. In some embodiments, motor vehicle 12 has an alarm system that is adjustable by occupant such that when collar 5 is out of a preset range of motor vehicle 12, the alarm sounds. In some embodiments, the motor vehicle 12 can have a settable range that allows collar 5 to send a shock to companion animal 3 when companion animal 3 is on the border of the preset range.

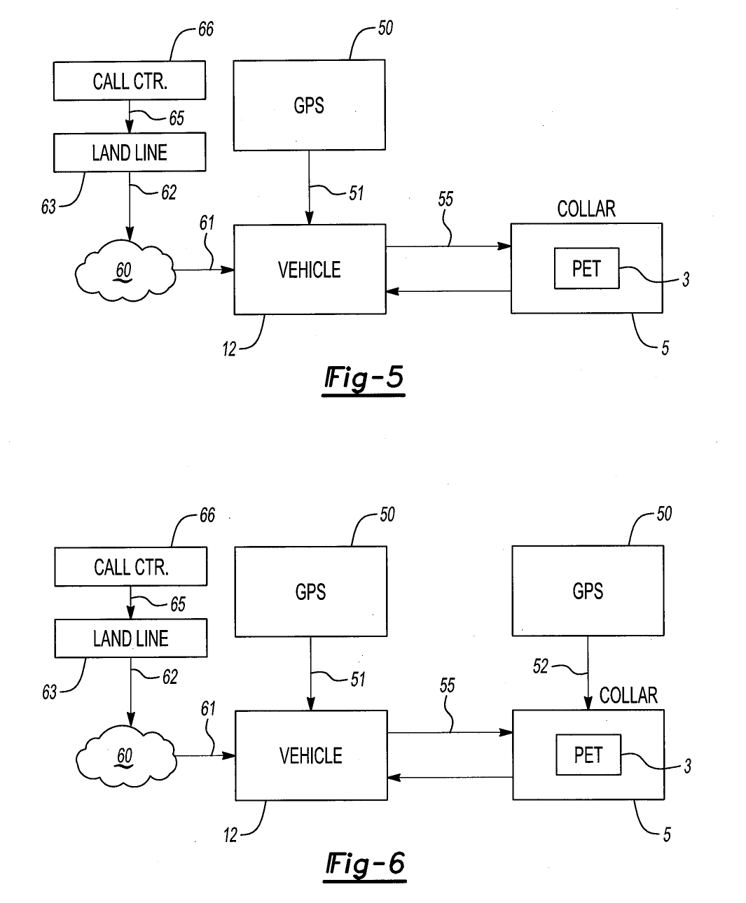

In some embodiments, as illustrated in FIG. 4, GPS 50 is in communication 52 with collar 5 and collar 5 broadcasts a signal to motor vehicle 12 which is received. In some embodiments, such signal can be tracked on a screen of a navigation system in motor vehicle 12. With reference to FIG. 5, the system as illustrated in FIG. 3 has additional components of communication 61 from motor vehicle 12 to cellular network 60. Cellular network 60 communicates 60 to a landline 63 which is in connection 65 to a call center 66. Examples of such telematics can be found in motor vehicle 12 that has OnStar™. Examples of such systems include U.S. Pat. Nos. 6,032,054, 6,728,612, 6,775,613, 6,853,907, 6,853,910 and 6,947,732. In some embodiments, call center 66 can alert occupant of motor vehicle 12 that companion animal 3 is out-of-range of motor vehicle 12. In some embodiments, when motor vehicle 12 has stopped and companion animal 3 has been allowed to exit motor vehicle 12, when motor vehicle 12 is later in motion and companion animal 3 is left behind, call center 66 can alert motor vehicle 12 that occupant has left companion animal 3 behind. Call center 66 can assist occupant of motor vehicle 12 in locating companion animal 3 by use of GPS 50 and communication 55 between collar 5 and motor vehicle 12.

With reference to FIG. 6, some embodiments have an additional communication 52 of GPS 50 and collar 5. In some embodiments, the range between motor vehicle 12 and companion animal 3 can be increased due to the location of collar 5 being identified by GPS 50. As referenced in FIG. 3, in some embodiments, the call center 66 can identify the exact location of companion animal 3 through use of GPS 50. In some embodiments, the call center 66 can contact the occupant of motor vehicle 12, determine where companion animal 3 is, and assist occupant in locating and recovering companion animal 3.

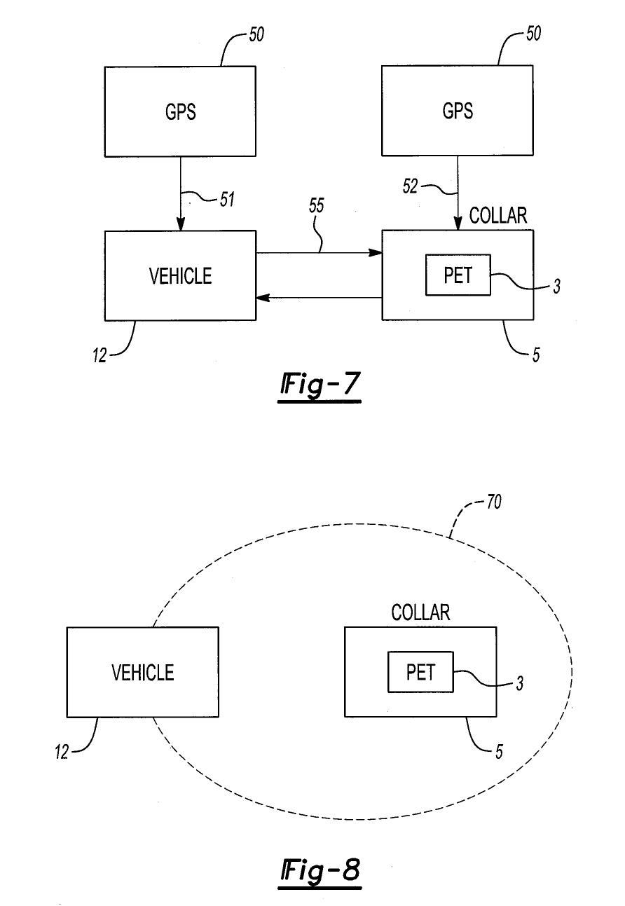

With reference to FIG. 7, a system similar to FIG. 6 is shown without the interface to a call center 66. In some embodiments, GPS 50 communication 52 to collar 5 can be tracked by motor vehicle 12 on a navigation system (not shown). In some embodiments, motor vehicle 12 can broadcast a tunable area or range such that companion animal 3 wearing collar 5 will not move out of electronic containment area 70. Such an invisible fence can be used to keep companion animal 3 near motor vehicle 12 during a short stop. In some embodiments, motor vehicle 12 can be at a rest stop, motor vehicle 12 broadcasts electronic containment area 70, companion animal 3 wearing collar 5 is released from motor vehicle 12 and is contained within area 70. In some embodiments, when companion animal 3 wearing collar 5 goes to edge of area 70, an alarm which can be a noise, a voice command, a light, electrical shock, or other type deterrent will keep companion animal 3 from wandering outside containment area 70.

In some embodiments, the GPS 50 can be a GPS logger which logs the position of the collar 5 at regular intervals in an internal memory and data may be downloaded, in real time, in intervals, or at a later time, to the vehicle 12, to a memory card, a computer, a network, the internet, or to the call center 66. In some embodiments, the GPS 50 can be a GPS data pusher that pushes the position of the collar 5 at regular interval to the vehicle 12, a computer, a network, or to the call center 66. In some embodiments, the GPS 50 can use SMS services. In some embodiments, the collar 5 can comprise a GPS receiver and a mobile phone both powered by a battery. At regular intervals, the phone sends a text message via SMS containing the data from the GPS receiver. The text message can be received by the vehicle 12, the call center 66, a network, the internet, a email address, a communication device 85 such as for example another cell phone, or a PDA, and the like, as described herein. In some embodiments, the GPS 50 can be a data puller that send the position of the collar 5 at regular intervals. In some embodiments, the GPS 50 can be available at all times for a queries by the vehicle 12, the call center 66, a network, the internet, a communication device 85 such as for example another cell phone, or a PDA, and the like, as described herein.

In some embodiments, initializing and ending communication between the vehicle 12 and the collar 5 can be controlled by an automated door locking system in the vehicle 12. For example while the vehicle 12 containing companion animal 3 is traveling, the vehicle is not in communication with the collar 5. When the vehicle stops and an occupant 80 opens the door, the vehicle 12 starts communication with collar 5. This can allow tracking of the companion animal 3 if it escapes when the door is opened. The vehicle 12 can track the collar 5 using methods described herein and/or the vehicle 12 can establish a containment area 70 for the companion animal 3 using methods described herein. When the vehicle starts to move and the doors automatically lock, the vehicle 12 identifies the location of collar 5. If the collar is in the vehicle 12, the communication of the vehicle 12 with the collar 5 end. If the collar is not in the vehicle 12, then the vehicle 12 or call center provides a warning to the occupant 80 of the vehicle 12 alerting the occupant 80 that the companion animal 3 has been left behind.

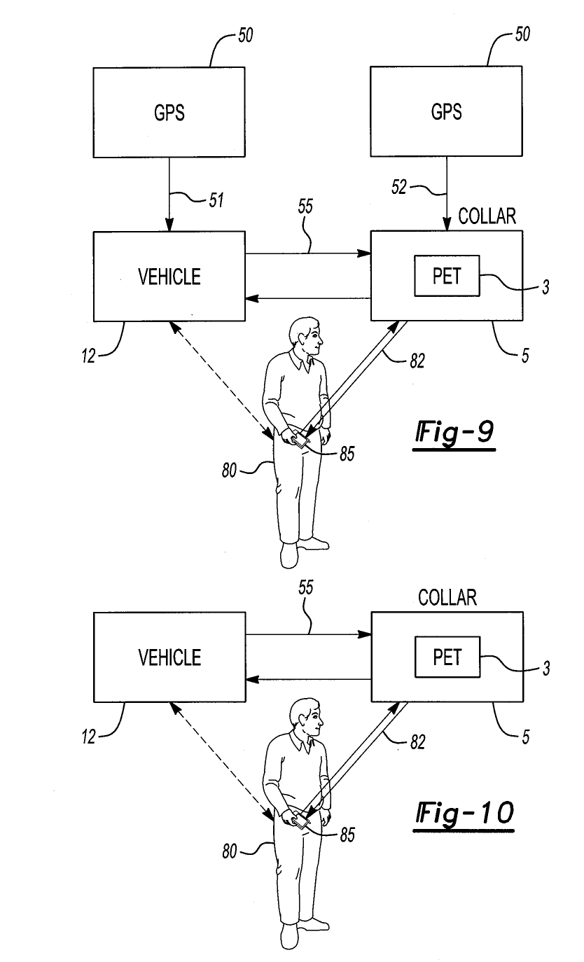

In some embodiments, as illustrated in FIG. 9, the system as illustrated in FIG. 6, can have additional means to communicate with collar 5. Occupant 80 can leave motor vehicle 12 and use a communication device 85 which can be a PDA, cell phone, radio keypad, or other type of hand-held device which has the ability to communicate 82 with collar 5. Occupant 80 can be able to track companion animal 3 in areas where motor vehicle 12 can not be able to enter. In addition, hand-held device 85 can be able to broadcast a containment area 70 such that occupant 80 can walk companion animal 3 and keep companion animal 3 within the safety of containment area 70. With reference to FIG. 10, motor vehicle 12 communication 55 with collar 5 on companion animal 3. Occupant 80 can leave motor vehicle 12 and have hand-held device 85 as means to communicate 82 with collar 5. In some embodiments, communication 55 and communication 82 can be by means of RFID, examples of RFID technology in an animal collar can be found in U.S. Pat. Nos. 6,502,060 and 6,721,681. Examples of such telematics are known in the art and can be found in U.S. Pat. Nos. 6,144,938 and 6,960,990 and US Patent Publication Nos. 2004/0023647, 2004/0203461 and 2004/0203692. Examples of telematics that are well-known in the art and available to consumers include OnStar™ which can be equipped on GM or BMW vehicles.

Some embodiments and the examples described herein are exemplary and not intended to be limiting in describing the full scope of compositions and methods of these teachings. Equivalent changes, modifications and variations of some embodiments, materials, compositions and methods can be made within the scope of the present teachings, with substantially similar results.

What is claimed is:

1. A companion animal convenience system for a motor vehicle, the system comprising:
a moveable partition, said partition comprising a frame and netting attached said frame and said partition pivotally attached to a headliner of the vehicle;
a removable bedding apparatus comprising at least one mattress, a plurality of compartments and a rubberized surface between said at least one mattress and the vehicle; and
a collar operably sizeable to a companion animal and said collar in communication with the vehicle.

2. The companion animal convenience system according to claim 1 further comprising a GPS operable to identify a location of said vehicle.

3. The companion animal convenience system according to claim 1 further comprising a locking system operably locking said partition in at least one of an open and a closed position.

4. The companion animal convenience system according to claim 1 further comprising a call center operably in communication with the vehicle.

5. The companion animal convenience system according to claim 1 further comprising a GPS operably identifying the location of the collar.

6. The companion animal convenience system according to claim 1 further comprising an antenna on the vehicle operably communicating with a receiver on said collar.

7. The companion animal convenience system according to claim 1 further comprising an antenna on said collar operably communicating with a receiver on the vehicle.

8. The companion animal convenience system according to claim 1 further comprising a RFID located in said collar, said RFID operably in communication with the vehicle.

9. The companion animal convenience system according to claim 1 further comprising a handheld device operably in communication with said collar.

10. The companion animal convenience system according to claim 1 further comprising a single button operable to communicate with a call center to locate said companion animal.

11. The companion animal convenience system according to claim 1 further comprising an alarm operably alerting an occupant of the vehicle that said companion animal is outside of an established distance of the vehicle.

12. The companion animal convenience system according to claim 1 further comprising an alarm on said collar operably deterring said companion animal from wandering beyond an established distance from the vehicle.

13. The companion animal convenience system according to claim 1 further comprising an insulated bowl.

14. A companion animal locating system comprising:
a vehicle having an antenna operable to receive a signal; and
a collar sizable to a companion animal, said collar broadcasting said signal to said vehicle.

15. The system according to claim 14 further comprising a GPS in said vehicle and said signal is described by said GPS.

16. The system according to claim 14 wherein said antenna is operable to broadcast a signal and said collar is operable to receive said signal.

17. The system according to claim 16 wherein said antenna broadcasts a directional signal which is a boundary that contains said collar.

18. The system according to claim 16 wherein said antenna broadcasts when a vehicle door is unlocked.

19. The system according to claim 14 further comprising a moveable partition, said partition comprising a frame and netting attached said frame and said partition pivotally attached to a headliner of said vehicle.

20. The system according to claim 14 further comprising a removable bedding apparatus comprising at least one mattress, a plurality of compartments and a rubberized surface between said at least one mattress and the vehicle.

21. A method of finding an animal, the method comprising:
providing a vehicle having an antenna that is operable for at least one of broadcasting and receiving a signal to a call center fitting the animal with a collar, said collar in communication with said vehicle;
communicating said call center for a location of the animal;
identifying the location of the animal wearing said collar; and
driving said vehicle to the location of the animal

21. The method according to claim 21 wherein said having an antenna is integral to a GPS in said vehicle and tracking a signal from said collar on said GPS.

22. The method according to claim 21 further comprising putting in said vehicle, said vehicle comprising a moveable partition, said partition comprising a frame and netting attached said frame and said partition pivotally attached to a headliner of said vehicle and a removable bedding apparatus comprising at least one mattress, a plurality of compartments and a rubberized surface between said at least one mattress and said vehicle.
